(19) United States
(12) Patent Application Publication
(10) Pub. No.: US 2006/0286362 A1
(43) Pub. Date: Dec. 21, 2006

(54) Methods for preparing composite materials

(76) Inventor: Masanori Kubota, Hockessin, DE (US)

Correspondence Address: RATNERPRESTIA, P.O. BOX 1596, WILMINGTON, DE, 19899, US

(21) Appl. No.: 11/233,274

(22) Filed: Sep. 22, 2005

Related U.S. Application Data
(63) Continuation-in-part of application No. 11/214,306, filed on Aug. 29, 2005.
(60) Provisional application No. 60/691,845, filed on Jun. 20, 2005.

(51) Int. Cl. C09J 5/02; B32B 27/04; B32B 27/12; B05D 3/02

(52) U.S. Cl. 428/297.4; 156/307.4; 427/372.2; 427/394; 428/300.7

(57) ABSTRACT

Composite materials are provided, incorporating an infrared absorbing layer that is heated by exposure to infrared radiation, thereby softening it and allowing formation of a consolidated composite material. One or more other structural materials are incorporated with the infrared absorbing layer, and bound together by it. An thermal insulating layer may be incorporated between the structural materials and the infrared absorbing layer.

### CROSS REFERENCE TO RELATED APPLICATIONS

This application claims the benefit of priority to U.S. Provisional application Ser. No. 60/691,845, filed Jun. 20, 2005, and U.S. application Ser. No. 11/214,306, filed Aug. 29, 2005, the contents of both of which are fully incorporated herein by reference.

### FIELD OF THE INVENTION

The present invention relates, in general, to forming composite materials. More specifically, the present invention relates to forming composite materials using electromagnetic radiation and a controlled amount of a radiation absorbing agent.

### BACKGROUND OF THE INVENTION

Heating polymeric materials for secondary processing in polymeric parts fabrication is an important and critical process in manufacturing and assembly of a number of manufactured articles. Heating polymeric parts is commonly done in the industry by using a hot air convection, hot plate conduction or infrared radiation heat source to heat the part by heat conduction through the surface. The industry is moving toward using thermoplastic resins to build composite parts that can be reformed, reworked or joined to use the parts in further manufacturing processes.

A typical method of forming polymeric parts employs preparing a prepreg material, a tow placement process, and autoclave consolidation. The prepreg material is formed using a polymer resin and a high tenacity fiber material in a composite matrix. The polymer can be a thermoset or thermoplastic resin. The high tenacity fibers commonly used in making composites include carbon, glass fiber, polyaramide fiber, high tenacity polyethylene fibers and others.

Currently, thermoset resins are the ones most commonly used for making prepregs. The prepreg reinforced polymer composite material is used in a tow placement process to position the composite material onto a tooling in the shape of the part to be manufactured. A composite part is constructed by winding layers of a prepreg composite material onto a tooling. After winding, the part is placed into an autoclave to apply heat and pressure to consolidate the part.

The heating process is done in ramped stages so that the prepreg layers are gradually heated by conduction heating. During the conduction heating process, the thermoset resin chemically reacts to bond the individual prepreg materials to form a continuous solid composite in the form of the final part. During consolidation, the prepreg material bonds together, eliminating any physical gaps within the prepreg material and expelling trapped air or gas. If the prepreg is made using a thermoplastic resin instead of a thermoset resin, the autoclave heating and pressure process heats the resin by conduction to the glass transition temperature where it consolidates by melt flow to eliminate physical spaces and trapped gas from the solid composite part.

Such composite manufacturing processes have features that may result in any of a variety of challenges. For example, when automated tow placement (ATP) is used to form composite parts, the prepreg is robotically managed and continuously fed onto a tool or part surface to lay-up the composite material part. Multiple layers of prepreg are bonded into a part shape by the application of heat and pressure. However, some core fiber materials have limited heat and radiation tolerance, restricting their use in composite manufacturing. Also, it is extremely difficult to achieve bonding quality using prepregs made using low-flow and low-volume resin matrix materials. During lay-up, a low volume resin prepreg may readily bond to the vertical neighbor but may fail to bond adequately to adjacent prepreg on the part form. This can result in low quality parts or part failure. Another issue is in the heat treatment process, done in an autoclave, to fully cure the layed-up composite part. Heat is applied to the part from the outside surface. Curing the prepreg lay-up relies on thermal conductivity of the heat throughout the complicated composite structure. U.S. Pat. No. 5,360,671 teaches that the batch heating process in the autoclave takes approximate 7 hours. Very sophisticated temperature control is required to achieve uniform results using the current methods.

Complicated thermal treatment is required to apply an even heat throughout the composite while curing the part structure. Even heating is needed to control the polymer crystallinity and avoids changes in polymer properties within the composite. It is well known that polymer crystallinity can change when the polymer is exposed to rapid changes in heat and pressure, and this is especially true when dealing with the high heat mass present in many traditional composite thermal treatment processes. Rapid heating of the composite mass may cause surface decomposition and degradation, while quick cooling may cause crystallinity changes in the polymer. A crystallinity change will typically affect the tenacity performance and chemical resistance of the polymer or composite, and may be undesirable.

For these and other reasons, it would be desirable to be able to form and to manufacture reinforced polymer composite parts without using processes that involve long heating times, especially in combination with high temperatures, such as autoclaving processes.

### SUMMARY OF INVENTION

In one aspect, the invention provides a composite structure including a base film or a plurality of base fibers, a functional layer including a first polymer on the film or on each of the plurality of fibers, and a radiation absorbing layer on the functional layer, wherein the radiation absorbing layer includes a second polymer having dispersed therein a near infrared absorber.

In another aspect, the invention provides a method of making a composite material. The method includes the steps of:

a) providing a plurality of base fibers each having thereon a functional layer including a first polymer; and

b) applying to the plurality of fibers of step a) a radiation absorbing layer, wherein the radiation absorbing layer includes a second polymer having dispersed therein a near infrared absorber.

### BRIEF DESCRIPTION OF DRAWINGS

The invention is best understood from the following detailed description when read in connection with the accompanying drawings. It is emphasized that, according to common practice, the various features of the drawings are not to scale, and not intended to be used as engineering drawings. On the contrary, the dimensions of the various features are arbitrarily expanded or reduced for clarity. Included in the drawings are the following figures. Each of FIGS. 1-4 provides a cross section view at the interface of the pseudo-transmission absorber interface and the polymeric parts being reformed or joined.

FIG. 1 Schematically illustrates pseudo-transmission forming of reinforced thermoplastic composite material.

FIG. 2 Schematically illustrates a single fiber with an insulating layer and a pseudo-transmission layer on the surface thereof, according to the invention.

FIG. 3 Schematically illustrates a fiber matrix with an insulating layer and a pseudo-transmission layer on the surface thereof, according to the invention.

FIG. 4 Schematically illustrates infrared exposure equipment suitable for use according to the invention.

### DETAILED DESCRIPTION OF THE INVENTION

The invention provides a process that uses controlled absorption of electromagnetic radiation and more particularly infrared irradiation in forming polymeric parts comprising a fiber core and a surrounding polymer matrix, without excessive heating of the fiber core. The irradiation process is accomplished by using a radiation absorber dispersed within a polymer part. The radiation absorber imparts the ability to partially absorb radiation and partially transmit radiation that is projected onto and through the polymeric part. The radiation is partially absorbed by a discrete pseudo-transmission polymeric layer and during the absorption process simultaneously heats the entire polymeric layer. As used herein, the term “pseudo-transmission” refers to partial transmission and partial absorption of radiation falling on a film or other object. In one embodiment, a radiation source is used in the process that projects near-infrared radiation onto the partially transmitting infrared absorber polymeric part. The radiation source can be a monochromatic laser type source or a polychromatic source having a radiation emission wavelength range between 700 nm and 2,000 nm.

A near-IR absorber is used to sensitize the polymer to be partially transparent to radiation. The absorber is sensitive to absorbing radiation in the wavelength range between 700 nm and 2,000 nm. The near-IR absorber can be dispersed into the polymer or applied to the surfaces of the polymer that is being formed or joined in the process. The near-IR absorber is dispersed or coated at a concentration to partially absorb and partially transmit near-IR radiation. The resulting pseudo-transmission infrared radiation (PTIR) method achieves controlled forming or joining of polymeric parts.

There are several key advantages to using the PTIR process for forming polymeric composites. The radiation passes into the absorption layer of the polymer and heats the entire layer simultaneously and the polymer heating process is very fast. The radiation can be precisely controlled during the heating process and only the portion that needs to be softened is heated. Therefore, only a small mass of polymer is heated and the heating and cooling cycle times are rapid. The radiation is projected through the reform layer uniformly, reducing the possibility of degrading the surface of the reformed polymer.

The near-IR radiation source can be a laser or polychromatic light source. The emission near-IR radiation from the source is at a wavelength between 700 nm and 2,000 nm. Various suitable apparatuses and methods of irradiating a surface or part using a radiant energy source are disclosed in U.S. Pat. No. 6,369,845 and U.S. Pat. No. 6,816,182 which are both incorporated herein by reference for their teachings in the art of irradiation of a surface using a radiant energy source. The deep focal penetration radiation source described in U.S. Pat. No. 6,816,182 is ideal for use as a radiation source for the PTIR application.

The optimum concentration of the absorber dispersed within the polymer layer is dependent on the thickness of the polymer wall, the absorptivity of the polymer and the absorptivity of the near-IR absorber. The objective is to project IR radiation throughout the PTIR polymer layer and have the radiation absorbed throughout the polymer layer to rapidly heat the polymer layer so that it will melt. The melted PTIR layer will conduct heat to and melt the interface at the surface of adjacent polymer layers while pressure is applied. The pseudo-transmission process will work in the range of 1% to 99% transmission for the pseudo-transmission layer. The optimum absorption value for near-IR radiation is 75% for the combined absorption of the polymer, and the absorber added to the polymer, in the pseudo-transmission layer.

The percentage by weight of infrared absorber dispersed in the polymer layer must be at a concentration that absorbs sufficient radiation to melt or soften the polymer so that it may bond to adjacent polymer parts. The concentration is set so that the layer is somewhat transparent to infrared radiation. Enough radiation must be absorbed in the layer to melt or soften it and thus bond the polymer to the part at the top surface of the interface (i.e., the part nearer the infrared source), while at the same time enough radiation must penetrate into and through the layer to a sufficient depth to melt or soften the bottom of the layer to bond it to the polymer on the bottom surface of the interface (i.e., side farther away from the infrared source). The polymer layer must also melt or soften sufficiently to flow into the gaps at the surface interface, optionally with the aid of pressure.

The percentage by weight (concentration) of absorber dispersed in the polymer will depend inter alia on the type of absorber and absorption efficiency (absorption coefficient) of the absorber. The known relationship for calculating the absorption based on the concentration of absorber dispersed into the polymer and the PTIR layer thickness is:
Absorption(%)=log(1/T)=A1B1+A2B1C2
A=absorption coefficient, B=thickness of layer, C=concentration absorber,
1=polymer, 2=IR absorber
The polymer itself may have some ability to absorb IR in the 700 nm to 2,000 nm range. The % A is measured across the wavelength output range for the near-IR radiation source.

The PTIR layer with the optimum partial absorption characteristics may be made by uniformly dispersing an infrared absorbing material throughout the PTIR polymer layer. Infrared absorbing materials that can be dispersed include carbon black, graphite, charcoal, talc, glass filler, ceramics, metal oxides, phthalocyanine pigment, and other infrared absorbing organic or inorganic pigments or dyes known in the art. Metal powders, such as stainless steel, brass, aluminum, copper and others can also be dispersed in the polymer matrix as infrared absorbers. The IR absorber is dispersed into the polymer using dispersion techniques known to the industry.

Polymer materials used as a matrix in preparing the PTIR layer may be any of a variety of thermoplastics, including polyolefin, polyamide, polyester, polyacrylate, polycarbonate, polystyrene, polyurethane and polyvinyl chloride. Engineering thermoplastics such as polyimide, polyamideimide, polyketone and polyetheretherketone can be used. Other types of polymers that can be used include fluoropolymers and thermoelastomers including thermoelastomer olefins and thermoelastomer vulcanizates.

Thermoset plastics such as polyimide and epoxy resin, phenolic resin, urea resin, melamine resin, unsaturated polyester resin, polyurethane are also useful. A preferred thermoset polyimide is SKYBOND 700, made by Industrial Summit Technology Company, 500 Cheesequake Road, Parlin, N.J. 08859. Another preferred material is 2214 epoxy resin, available from 3M Company of St. Paul, Minn.

The PTIR polymer can be formed as a discrete partial absorber layer by cast coating or extruding the polymer with absorber into a film. The absorber-polymer can be formed into a PTIR layer by using two-color molding or co-extrusion. The polymer can be extruded into other forms such as tubing, parts, etc.

The optimum concentration of the absorber dispersed within the polymer is dependent on the thickness of the polymer layer, the absorptivity of the polymer and the absorptivity of the near-IR absorber. The objective is to project IR radiation throughout the polymer layer and have the radiation absorbed throughout the polymer layer to rapidly heat the polymer layer so that it will reform when tooling under pressure is applied. The pseudo-transmission process will work in the range of 1% to 99% transmission for the pseudo-transmission layer, with a transmission value of 25% being the optimum for near-IR radiation. (Conversely, the optimum absorption value is 75%.) The transmission value (or absorption) is for the combined transmission (or absorption) of the polymer part thickness and of the radiation absorber dispersed within the polymer in the pseudo-transmission layer.

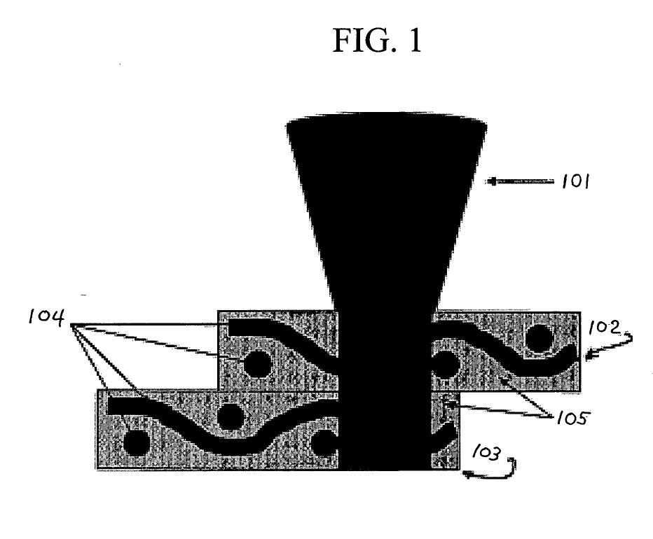

An exemplary embodiment of the present invention provides a pseudo-transmission infrared radiation (PTIR) method for consolidation, forming and joining reinforced thermoplastic composite materials as shown in FIG. 1.

A near-IR source projects radiation 101 onto and through the reinforced thermoplastic composite layers 102 and 103. The reinforced thermoplastic composite layer composition includes a thermoplastic resin with a pseudo-transparent IR absorber dispersed within the resin 105 and a high tenacity reinforcing fiber 104 held within the composite structure. The radiation 101 is partially absorbed by the absorber in the resin and simultaneously heats the discrete layers of resin. The resin is heated to the glass transition point so that the resin layers 102 and 103, which may optionally be pressed together to improve contact, will melt or soften and then flow together at the interface to form a composite part. Multiple layers of reinforced thermoplastic composite can be laid down and built into a composite part. The near-IR radiation source may be as described herein above.

The resins used in preparing the PTIR composite layer 105 can be selected from the family of thermoplastics including engineering thermoplastics such as polyimide, polyamideimide, polyketone and polyetheretherketone can be used. In general, any of the thermoplastics and infrared absorbing materials described herein above may be used.

The high tenacity fibers 104 that can be used in making the composite layer include any of a variety of fibers. Nonlimiting examples including glass, metal alloys, steel, graphite, quartz, carbon, boron, silicon carbide, alumina, aramid polymers, liquid crystalline polymers, and ultra high molecular weigh polyethylene polymers. One exemplary fiber type is sold under the trade name VECTRAN 1200 by Celanese Corporation, and is a liquid crystalline aromatic polyester. The PTIR composite layer can be formed by coating the high tenacity fibers with the thermoplastic resin containing the PTIR absorber. The fiber geometry within the composite layer can be unidirectional in a prepreg configuration, or they may be woven in a two-dimensional configuration and coated with the resin polymer containing the PTIR absorber. Coating techniques known to the industry can be used in preparation of the PTIR composite layer.

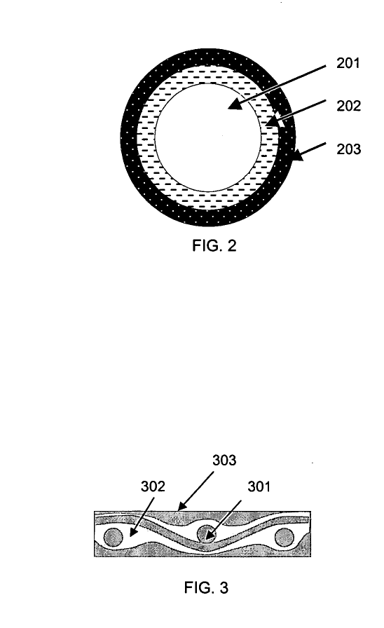

In another embodiment of the invention, a functional layer is interposed between a core fiber and an outer PTIR layer. Referring to FIG. 2, the core material 201 is a high tenacity fiber material that incorporates high performance mechanical properties into the composite. The core fiber material may be selected from any of the fiber materials described in the preceding paragraph.

Layer 202 is a functional layer, at least one function of which is to provide insulation of the core fiber 201 from high temperatures. The functional layer can be made from a thermoplastic polymer, thermoset polymer or a ceramic material that is compatible with and coated onto the core fiber material. Fillers can be added to the functional layer to optimize performance. For example, a filler-doped polymeric layer 202 may reflect near infrared, block conduction of heat, and/or provide abrasion resistance and/or radiation resistance. Aluminum oxide, zirconium oxide, titanium dioxide, metal flakes, ceramics, silicon carbide, and solid or hollow ceramic materials are exemplary materials that can be used as filler. Layer 202 will typically have absorption of near infrared radiation less than 50% and a thickness of at least 1 nm, to minimize infrared absorption so that heating of the adjacent core material 201 is minimized, and to reduce heat conduction from heated welding polymeric layer 203, respectively.

Outer layer 203 is a PTIR layer comprising a polymer and an infrared absorber as described herein above. It may contain a thermoplastic or uncured thermoset polymer that is compatible with and coated onto the functional layer material. The dispersed absorber can be carbon black, organic or inorganic pigment or dye, such as a phthalocyanine, or any other known near-infrared absorber such as described herein above. The outer layer absorbs a portion of near-infrared radiation from a suitable source, such as described above, thereby heating it and causing it to soften or melt. The outer layer is translucent to near infrared radiation, allowing radiation to pass into and through the multi-layer composite structure. Outer layer 203 may be coated, laminated, or laid up on the functional layer 202. Typically, outer layer 203 will absorb at least 1% of the near infrared light, but typically no more than 75%.

Referring now to FIG. 3, the multi-layer composite may be made by first coating the functional layer 302, as a liquid coating, onto the core fibrous material 301 and drying, followed by coating the outer layer 303, also a liquid, onto the functional layer 302 and drying. The core fibrous material may be in any form, including a tow, a woven material, a nonwoven material or an other fibrous form. The subsequent thermoplastic composite material can be finished in a prepreg form. In some embodiments, lay-up of encapsulated prepreg onto a part form may be done using the ATP process. Up to 6 or more layers of prepreg can be placed and simultaneously welded into a single composite part using a near-infrared radiation unit. Use of this method for manufacture of composite parts can significantly reduce the cycle time.

The multi-layer composite can also be made by first coating the functional layer 302, for example applied as a liquid coating, onto the core fiber and core fabric material 301 and drying, followed by lay-up film or fabric as the outer layer 303. Lay-up of the resulting encapsulated prepreg onto a part form can be done using the ATP process. Up to 6 or more layers of prepreg can be placed and simultaneously welded into a single composite part using a near-infrared radiation unit.

Suitable materials for forming functional layer 202/302 include any of a variety of polymers. Exemplary polymers include thermoset or thermoplastic polymers such as those described herein above for use in PTIR layers. Examples include epoxy thermoset resins, polyester-imides, polyamide-imides, polyester-imide/polyamide-imides, polyamides, and phenoxy or polyester-urethane polymers. Other useful examples include polyethylene, polymethyl methacrylate, polypropylene, or an ionomer, for example as applied in the form of a dispersion. In some embodiments, the polymer may be a thermoplastic polyimide. Particular examples of these include AURUM 450 and AURUM 500 polymers, available from Mitsui Chemicals America Inc. of Purchase, N.Y. AURUM is extrudable at 390-420° C. and has a melting temperature of about 388° C. and a glass transition temperature of about 250° C.

Suitable polymers and fillers for forming outer layer 203, 303 include any of the materials described above for forming functional layer 202, 302. Also useful are polyimides and thermoplastic elastomers. Examples include thermoplastic vulcanizate (TPV) elastomers, available from sources including Teknor Apex of Pawtucket, R.I., and polybutylene terephthalate (PBT) elastomers such as sold under the name CRASTIN by DuPont of Wilmington, Del.

Exemplary materials for forming outer layer 203, 303 include nonwoven products, examples of which include polypropylene products containing carbon black sold by Hanes Industries (Conover, N.C.) under the trade names ELITE 125 BLACK and #49644 ELITE 150 BLACK. Nonwoven products such as these may have a relatively light basis weight, in some cases about 20 g/m², and yet are easy to handle and lay up on forms to make composites according to the invention. Use of such light loadings of infrared-absorbing material tends to allow the generation of relatively little heat during forming of the composite material, due to the low thermal mass of the material. It also allows the composite to contain a higher relative proportion of core fiber by weight, thereby providing excellent physical strength properties. It is preferable that the weight ratio of the functional layer to the outer layer be at most 20:1. Typically, the ratio will be in the range of 3:1 to 1:1. In addition, it is generally desirable to maximize the infrared absorbing contrast between the outer layer 203, 303 and the functional layer 202, 302, so that heating is maximized in the former and minimized in the latter.

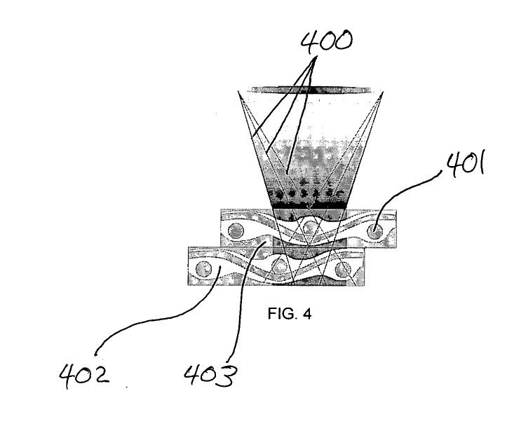

Near infrared radiation for heating the composite structures is typically in the 800 nm to 1,650 nm range, because most polymeric materials are transparent at these wavelengths. Preferably, the radiation has a high energy density with a conical shape beam, and has an elongated focal depth to deliver uniform energy to entire depth of the layers and minimize shadow effects from the upper layer structure. An example of a suitable infrared exposure arrangement is shown in FIG. 4. Near infrared light, indicated by rays 400 applied with varying depths of focus as shown, heat a lay-up such as shown in FIG. 3, containing fibers 401, functional layer 402, and PTIR layer 403.

Experiments have confirmed that the methods and structures described herein above greatly reduce heat mass in the composite material during processing, thereby reducing thermal treatment cycle time and providing little or no degradation of materials. Encapsulation of core material by thermal insulator layer 202/302 minimizes many temperature-related problems, such as melting or degradation of temperature-sensitive core fibers 201/301.

It is contemplated that the methods and structures described herein above will enable composite processing having excellent process latitude, a wider choice of useful materials, and rapid composite processing time. These methods are expected to significantly reduce the cost of composite part manufacture and increase composite utilization in the industry.

Although illustrated and described herein with reference to certain specific embodiments, the present invention is nevertheless not intended to be limited to the details shown. Specifically, a layer such as the functional layer hereinabove described may also be used in numerous other instances to protect an underlayer, such as, for example, when used to connect or weld separate pieces using a heat activated adhesive. Various other modifications may be made in the details within the scope and range of equivalents of the claims without departing from the spirit of the invention.

What is claimed:

1. A composite structure comprising a base film or a plurality of base fibers, a functional layer comprising a first polymer on the film or on each of the plurality of fibers, and a radiation absorbing layer on the functional layer, wherein the radiation absorbing layer comprises a second polymer having dispersed therein a near infrared absorber.

2. The composite structure of claim 1, wherein the composite structure comprises a plurality of base fibers.

3. The composite structure of claim 2, wherein the plurality of base fibers is in the form of a tow.

4. The composite structure of claim 2, wherein the plurality of base fibers is in the form of a fabric.

5. The composite structure of claim 1, wherein the functional layer further comprises a filler dispersed therein.

6. The composite structure of claim 1, wherein the first polymer is a thermoplastic polymer.

7. The composite structure of claim 1, wherein the first polymer is a thermoset polymer.

8. The composite structure of claim 1, wherein the second polymer is a thermoplastic polymer.

9. The composite structure of claim 1, wherein the base film or plurality of base fibers, the functional layer, and the radiation absorbing layer constitute a first unit, the composite structure further comprising one or more additional such units bonded to the first unit.

10. A method of making a composite material, the method comprising:
a) providing a plurality of base fibers each having thereon a functional layer comprising a first polymer; and
b) applying to the plurality of fibers of step a) a radiation absorbing layer, wherein the radiation absorbing layer comprises a second polymer having dispersed therein a near infrared absorber.

11. The method of claim 10, wherein the plurality of base fibers is in the form of a tow.

12. The method of claim 10, wherein the plurality of base fibers is in the form of a fabric.

13. The method of claim 10, wherein the functional layer further comprises a filler dispersed therein.

14. The method of claim 10, wherein the first polymer is a thermoplastic polymer.

15. The method of claim 10, wherein the first polymer is a thermoset polymer.

16. The method of claim 10, wherein the second polymer is a thermoplastic polymer.

17. The method of claim 10, wherein the base film or plurality of base fibers, the functional layer, and the radiation absorbing layer constitute a first unit, the composite structure further comprising one or more additional such units bonded to the first unit.

18. The method of claim 10, wherein the step of applying a radiation absorbing layer comprises applying a woven or nonwoven fabric comprising the second polymer and the near infrared absorber.

19. The method of claim 10, further comprising:
selecting for said radiation absorbing layer a polymeric material having dispersed therein an amount of the near infrared absorber such that at least a portion of infrared electromagnetic radiation incident on a first surface of said radiation absorbing layer exits from a second surface thereof; and
exposing the radiation absorbing layer to said infrared electromagnetic radiation through said first surface whereby a portion of said radiation is absorbed into said radiation absorbing layer, thereby heating said second polymer.

20. The method of claim 19, wherein the absorbing layer absorbs from 1% to 99% of the incident radiation.

21. The method of claim 19, wherein said second polymer is exposed to sufficient infrared radiation to heat said second polymer to a softened state.

22. The method of claim 19, further comprising pressure forming the softened polymer into a desired shape.

23. The method of claim 19, further comprising repeating steps a) and b) at least once.
